(19) United States
(12) Patent Application Publication
(10) Pub. No.: US 2007/0058382 A1
(43) Pub. Date: Mar. 15, 2007

(54) Grille of automobile

(76) Inventor: Yi-Tzu Lan, Zhonghe City (TW)

Correspondence Address: BIRCH STEWART KOLASCH & BIRCH, PO BOX 747, FALLS CHURCH, VA, 22040-0747, US

(21) Appl. No.: 11/225,025

(22) Filed: Sep. 14, 2005

(51) Int. Cl. B60Q 1/26

(52) U.S. Cl. 362/487

(57) ABSTRACT

A grille of automobile comprising a grille body, at least one light source and corresponding wires; the grille body comprises of an outer frame and a decoration board, the decoration board can be in different shape, several hollows are on the decoration board; the grille body is injected from a plastic mold in single body; the grille body can be made of transparent on non-transparent materials; at least one wedge slot is on the outer frame or the decoration board to install the light sources; based on the structure described above, the present invention is installed in front of the radiator, the structure is simple, convenient to assemble for lower manufacturing cost, better for air inhaling, cooling, safer driving in the evening and better outlooking.

### BACKGROUND OF THE INVENTION

I. Field of the Invention

This invention relates generally to a grille and, more specifically, to a grille of automobile that has shining light sources, the present invention does not effect the air ventilation also offer safer driving in the evening and better outlooking.

II. Description of the Prior Art

Heretofore, it is known that the grille of an automobile is installed in front of the radiator to inhale cool air and dissipate heat from radiator and engine, a protection net is on the inner wall of the grille to prevent insects, gravel stones from coming into engine, all the grilles in the market formed in single body, outlooking is simple without much change. Currently, a type of shining grille a is available in the market, such design is safer in the evening and better looking; referring to FIG. 1, the shining grille a has a shining device a2 installed inside the frame a1; the shining device a2 further comprises a decoration board a21, an LED circuit board a22 and a bottom cover a23, the LED circuit board a22 is installed between the decoration board a21 and the bottom cover a23, a filter a3 with the same physical size of the frame a1 is behind the bottom cover a23 of the shining device a2, the filter a3 and the shining device a2 are firmly fixed on the frame a1 with screws; the shining grille described above has benefits and good features, however, too many components might cause inconvenience during assembly that further increases manufacturing cost.

### SUMMARY OF THE INVENTION

It is therefore a primary object of the invention to provide a grille of automobile that is not only simple in structure, convenient to assemble to lower manufacturing cost, but also better for air inhaling, cooling, safer driving in the evening and better outlooking.

In order to achieve the objective set forth, a grille of automobile in accordance with the present invention comprises a grille body, at least one light source and corresponding wires; the grille body comprises of an outer frame and a decoration board, the decoration board can be in different appearances, several hollows are on the decoration board; the grille body is injected from a plastic mold in single body; the grille body can be made of transparent on non-transparent materials; at least one wedge slot is on the outer frame or the decoration board to install the light sources.

Based on the structure described above, while installation, the present invention replaces the original grille and is installed in front of the radiator; the wires of the light sources are connected to the battery, after ignition, the light sources emit light; the present invention is injected from plastic mold in single body, the structure is very simple, the light sources are firmly wedged into the wedge slot, assembly is also easy for lower assembly and manufacturing cost; after installation, the hollows on the decoration board vent air in and avoid gravel stones from coming in; no matter the materials are transparent or non-transparent, while light sources shining, shining light goes through decoration board directly or reflects from hollows of the grille for safer driving and better looking.

### BRIEF DESCRIPTION OF THE DRAWINGS

The accomplishment of the above-mentioned object of the present invention will become apparent from the following description and its accompanying drawings which disclose illustrative an embodiment of the present invention, and are as follows:

FIG. 1 is an assembly view of the prior art;

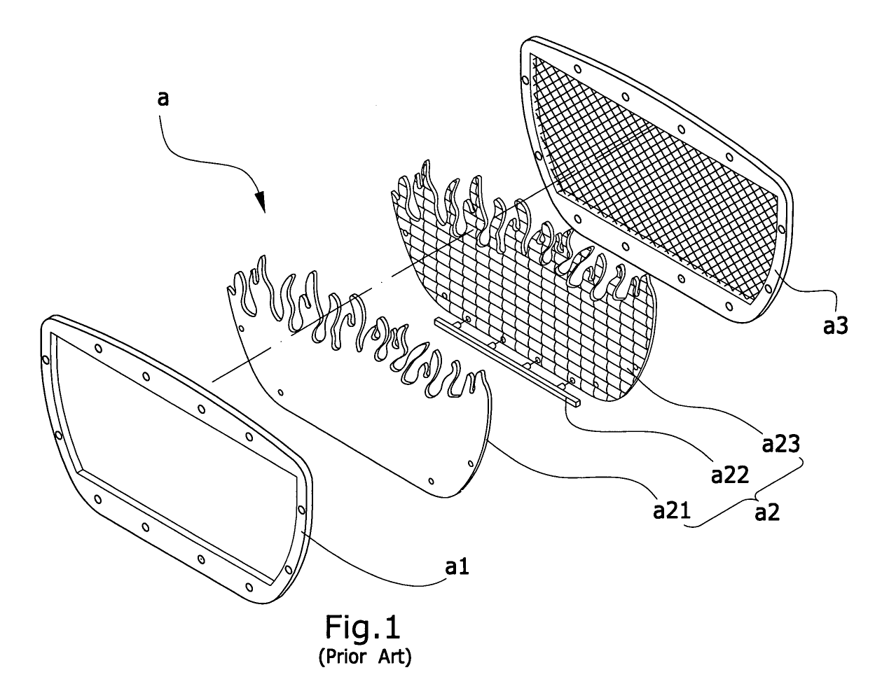

FIG. 2 is an assembly view of the present invention;

FIG. 3 is a perspective view of the first example of the present invention;

FIG. 4 is a perspective view of the of second example the present invention;

FIG. 5 is a perspective view of the third example of the present invention;

FIG. 6 is a perspective view of the fourth example of the present invention;

FIG. 7 is a perspective view of the fifth example of the present invention;

FIG. 8 is an application view of the present invention;

FIG. 9 is another application view of the present invention.

### DESCRIPTION OF THE PREFERRED EMBODIMENT

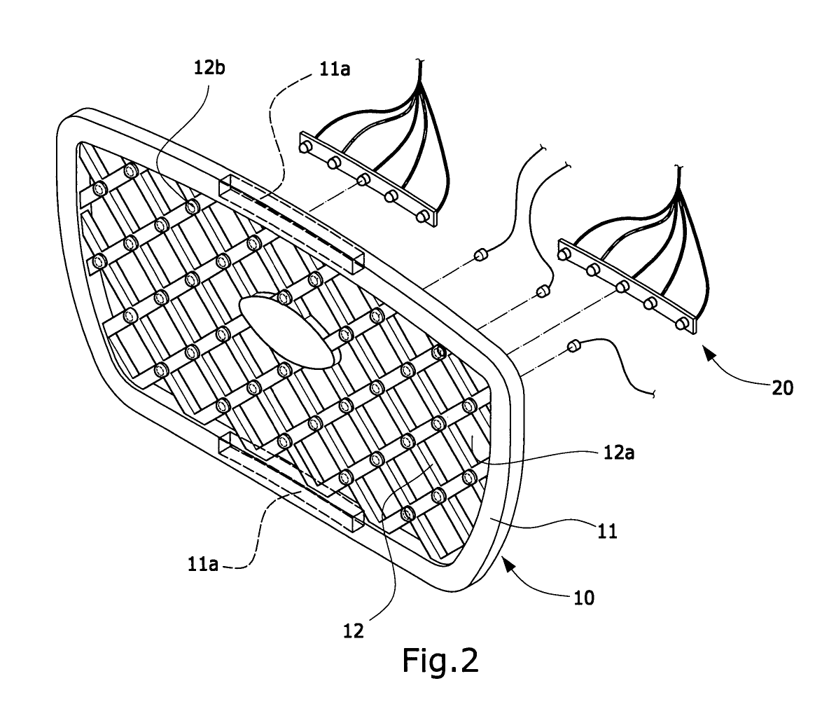

Referring to FIG. 2, the present invention comprises a grille body 10, at least one light source 20 and corresponding wires; the function of each component is described as following:

The grille body 10 comprises of an outer frame 11 and a decoration board 12, several hollows 12a are on the decoration board 12; the grille body 10 is injected from a plastic mold in single body; the grille body 10 can be made of transparent on non-transparent materials; at least one wedge slot 11a, 12b is on the outer frame 11 or the decoration board 12 to install the light sources 20 (such as LED, Neon light, Electron luminance EL, or color light bulbs).

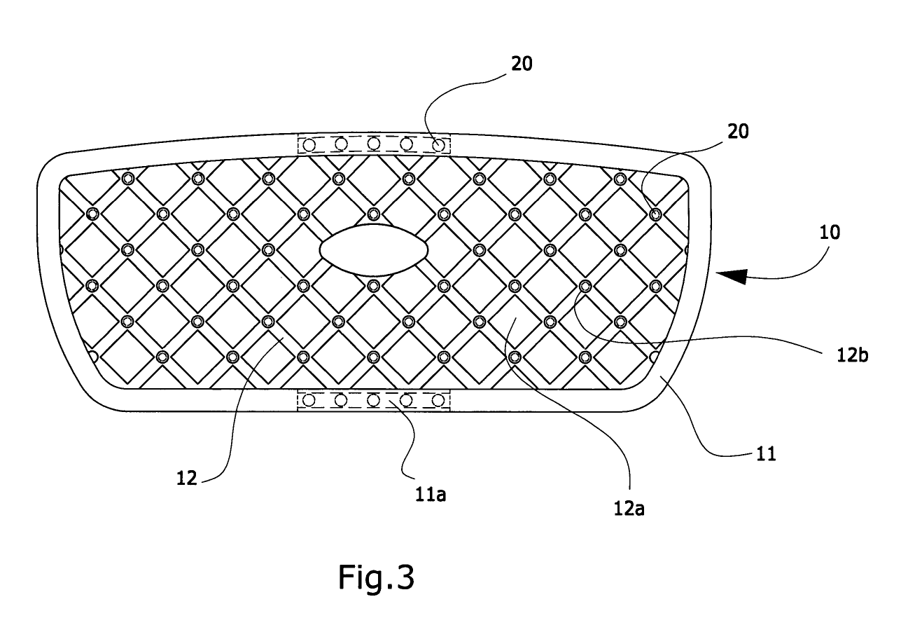

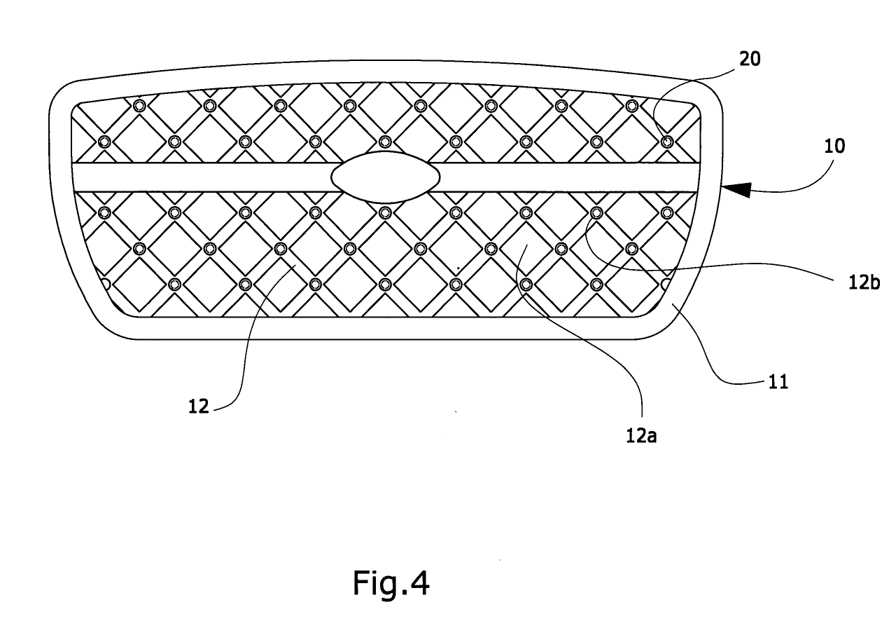

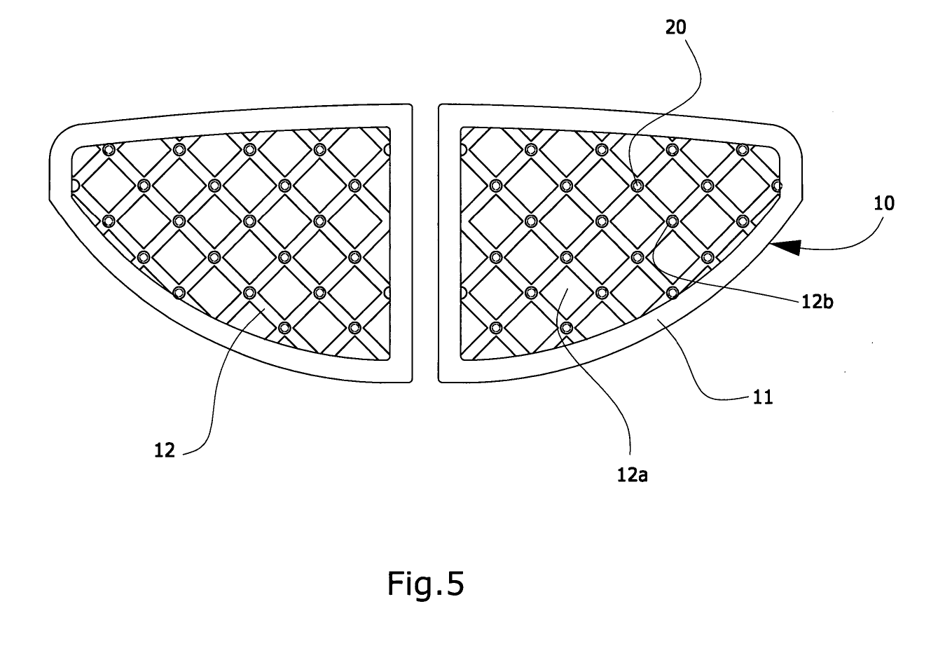

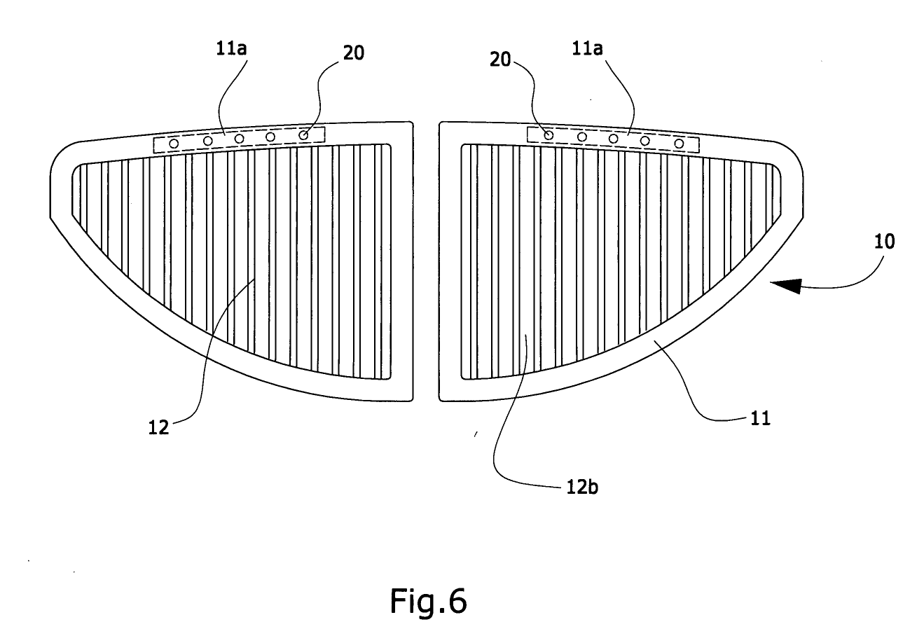

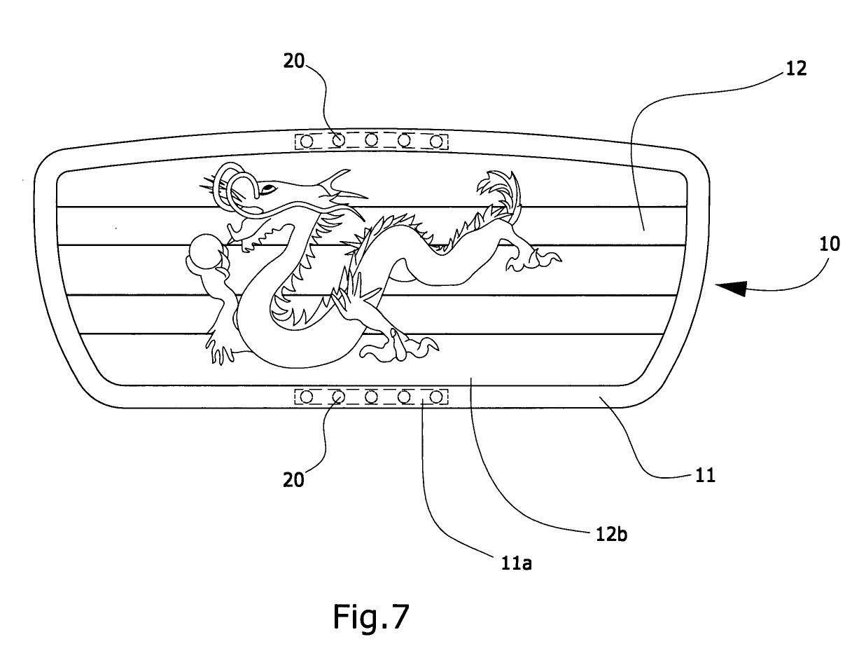

Referring to FIG. 3 to FIG. 7, several application views of the present invention, they are the combination of the grille body 10, the outer frame 11, and different internal decoration boards 12 with light sources 20 inside the wedge slots 11a, 12b, the decoration board 12 can be in different geometrical appearance (such as vertical railings in parallel, horizontal railings in parallel, interlaced grids or other shapes with hollows 12a).

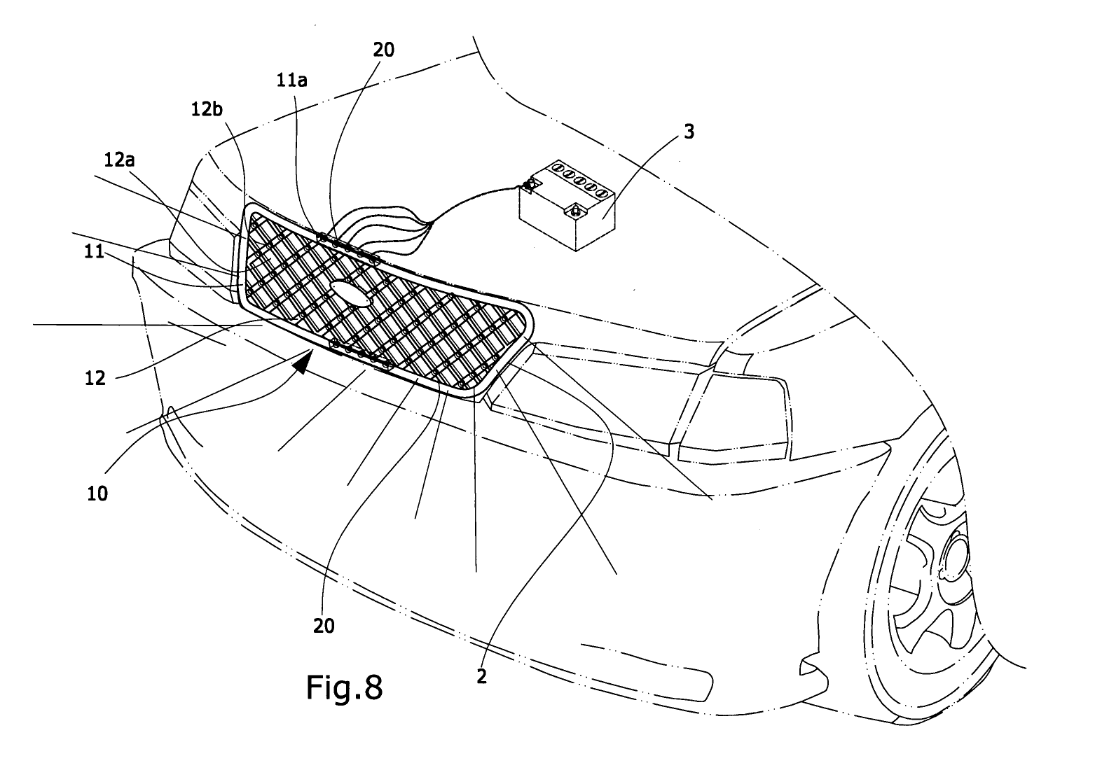

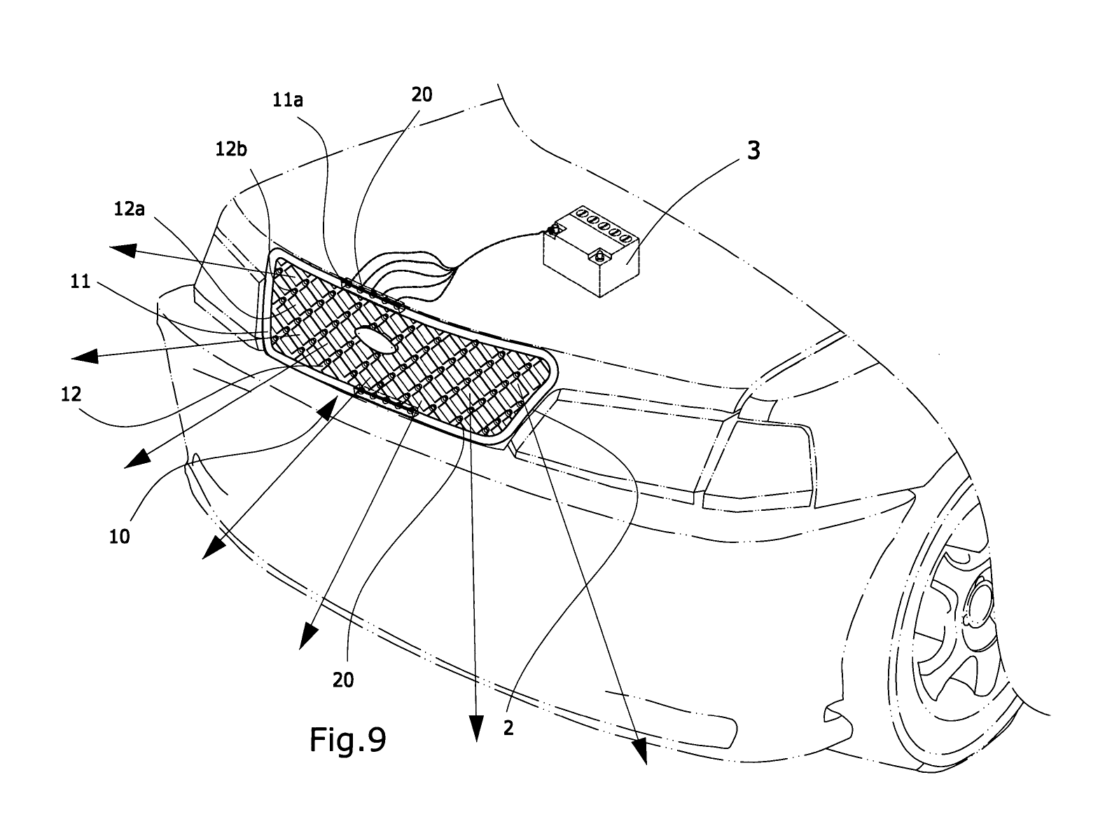

Referring to FIG. 8 and FIG. 9, different application views, the grille body 10 is installed in front of the radiator 2, the switch set 20 is connected to battery 3; after ignition, the light sources 20 inside the wedge slots 11a, 12b on the decoration board 12 or the frame 12 of the grille body 10 will shine, light emits from the decoration board 12 by transparent material directly or from the hollows 12a of the decoration board 12 by non-transparent material.

While a preferred embodiment of the invention has been shown and described in detail, it will be readily understood and appreciated that numerous omissions, changes and additions may be made without departing from the spirit and scope of the invention.

What is claimed is:

1. A grille of automobile comprising:
a grille body, at least one light source and corresponding wires, said grille body comprises an outer frame and a decoration board, several hollows are on said decoration board, at least one wedge slot is on said outer frame to install said light sources.

2. A grille of automobile comprising:
a grille body, at least one light source and corresponding wires, said grille body comprises an outer frame and a decoration board, several hollows are on said decoration board, at least one wedge slot is on said decoration board to install said light sources.

3. The grille of automobile comprising:
a grille body, at least one light source and corresponding wires, said grille body comprises an outer frame and a decoration board, several hollows are on said decoration board, at least one wedge slot is on said outer frame and said decoration board to install said light sources.

4. The grille of automobile recited in claim 1, wherein said grille body is injected from a plastic mold in single body.

5. The grille of automobile recited in claim 1, wherein said light source is LED's.

6. The grille of automobile recited in claim 1, wherein said light source is Neon light.

7. The grille of automobile recited in claim 1, wherein said light source is Electron luminance.

8. The grille of automobile recited in claim 1, wherein said light source is color light bulbs
